(19) United States
(12) Patent Application Publication
(10) Pub. No.: US 2005/0170151 A1
(43) Pub. Date: Aug. 4, 2005

(54) Method and apparatus for making fabric samples

(76) Inventors: Gary Dobson, Arlington, TX (US); Geoffrey Hirsch, Garland, TX (US); Allen Gastinger, Mansfield, TX (US); Nick Ulmen, Arlington, TX (US); James Bortzfield, Alvarado, TX (US); Jayson Owens, Burleson, TX (US)

Correspondence Address: DINSMORE & SHOHL LLP;Suite 500, One Dayton Centre, Dayton, OH, 45402-2023, US

(21) Appl. No.: 10/768,458

(22) Filed: Jan. 30, 2004

(51) Int. Cl. B32B 5/02; B32B 27/04; B32B 3/00; B32B 27/12

(52) U.S. Cl. 428/192; 428/194; 428/193; 428/195.1; 428/196; 442/149; 442/103; 442/104

(57) ABSTRACT

A method and apparatus for preparing fabric samples is provided. The method includes applying an adhesive in the form of a web at predetermined intervals along a length of fabric, and cutting the fabric into a series of individual fabric samples such that the adhesive overlies the first and second side edges of the fabric samples, preventing fraying of the edges. The apparatus includes rollers for applying the adhesive web onto the fabric and a heating device for heating and adhering the adhesive onto the fabric. The treated fabric samples may be assembled into a book or binder for use.

### BACKGROUND OF THE INVENTION

The present invention relates to a method and apparatus for making fabric samples. More particularly, the present invention relates to a method and apparatus for making fabric samples which prevents the margins of the samples from fraying.

Various types of binders or books have been developed for use in carrying or displaying samples of fabric and other materials. Such binders or books typically include at least a back cover for supporting a stack of fabric samples, and a header which includes fastening elements for retaining the fabric samples. The books often contain a front cover comprising a rigid material or a transparent vinyl material which protects the samples. However, while such structures provide support to the fabric samples and allow the samples to be easily displayed and viewed, the exposed side margins of the fabric samples are unprotected and may become frayed as the samples in the books are examined and/or transported by customers or sales personnel over time.

There are a number of adhesive agents and/or liquid resin solutions which have been employed to prevent fraying of fabric edges. See, for example, U.K. Patent No. 1,462,787. However, such agents are applied in the form of a liquid solution and the apparatus for applying the agents must include reservoirs for applying the material as well as means for removing excess agent.

It would be desirable to be able to apply a material which prevents fraying of the marginal edges of fabric samples in a more efficient manner. Accordingly, there is still a need in the art for a method and apparatus for making fabric samples which prevents fraying of the fabric sample edges when they are displayed or used in a sample book.

### SUMMARY OF THE INVENTION

The present invention meets that need by providing a method of making fabric samples in which an adhesive is applied to the back face side edges of the samples to prevent fraying of the edges. The treated fabric samples may then be assembled in a book or binder.

According to one aspect of the present invention, a method of making fabric samples is provided which comprises providing a length of fabric, applying an adhesive along the length of the fabric at predetermined intervals, and cutting the fabric into a series of fabric samples having first and second side edges and first and second end edges such that the adhesive overlies the first and second side edges of each fabric sample and prevents fraying of the edges.

The adhesive preferably comprises a hot melt adhesive, and is preferably in the form of a web. The adhesive is preferably heated after being applied to the fabric to melt the adhesive. The adhesive is then preferably cooled after heating.

The fabric preferably has a front face and a back face, where the adhesive is applied to the back face. After the treated fabric is cut into individual fabric samples containing the adhesive on their edges, the samples may then be assembled in a book or binder. Preferably, a strip of paper or plastic is adhered to least one end edge of each adhesive-treated fabric sample. The series of fabric samples are assembled in the form of a stack, and the stack may then be assembled in a book or binder for use.

The present invention also provides an apparatus for making fabric samples which comprises a conveyor for supporting and feeding a length of fabric, and a plurality of rotatable rolls supported above the fabric and positioned at predetermined intervals across the width of the fabric. The rotatable rolls contain an adhesive, preferably in the form of a web, for application to the fabric. The apparatus further includes a plurality of rotatable guide rolls positioned in alignment with the plurality of adhesive-containing rolls for applying the adhesive along the length of the fabric at the spaced intervals, and a device for heating and adhering the adhesive to the fabric. The apparatus also preferably includes a mechanism for cooling the adhesive after it is heated and adhered to the fabric.

Accordingly, it is a feature of the present invention to provide a method of making fabric samples in which an adhesive is provided on the edges of the samples to prevent fraying of the fabric edges when the samples are displayed or assembled in a sample book. Other features and advantages of the invention will be apparent from the following description, the accompanying drawings, and the appended claims.

### BRIEF DESCRIPTION OF THE DRAWINGS

FIG. 1 is a perspective view of an individual fabric sample having an adhesive on its side edges;

FIG. 2 is a perspective view of the apparatus for applying the adhesive to a length of fabric according to the invention; and

FIG. 3 is a flow diagram illustrating the method of assembling the adhesive-treated fabric samples into a sample book.

### DETAILED DESCRIPTION OF THE PREFERRED EMBODIMENTS

The method and apparatus of the present invention provide an efficient method for treating fabric samples for display or use in a sample book. By providing an adhesive on the side edges of the fabric samples, the samples are prevented from fraying when they are transported and/or examined repeatedly, e.g., in a fabric sample book. The adhesive used to protect the fabric edges is provided in the form of an adhesive web which melts upon the application of heat. Because the adhesive is in the form of a web, the application of adhesive does not require the use of heated rolls or special applicators which are required when the adhesive is applied in liquid form.

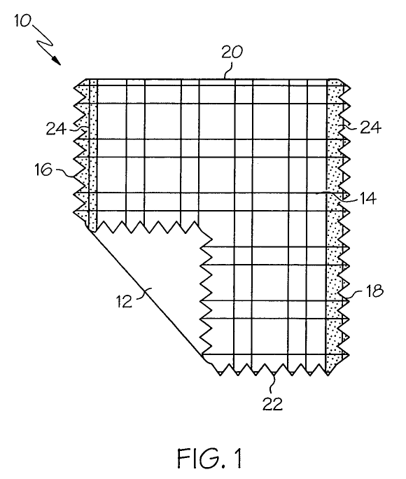

Referring now to FIG. 1, a fabric sample 10 including an adhesive in accordance with the present invention is illustrated. The fabric includes a front face 12 and a back face 14, first and second side edges 16 and 18, and first and second end edges 20 and 22. As shown, an adhesive 24 is applied along both of the side edges 16, 18 on the back face 14 of the fabric.

The adhesive is preferably a hot melt adhesive provided in the form of a web. A preferred web adhesive for use in the present invention is commercially available from Bostik Findley, Inc. under the designation PE75-40 or PE75-30. The adhesive web is preferably provided in continuous form on a roll as will be explained in greater detail below.

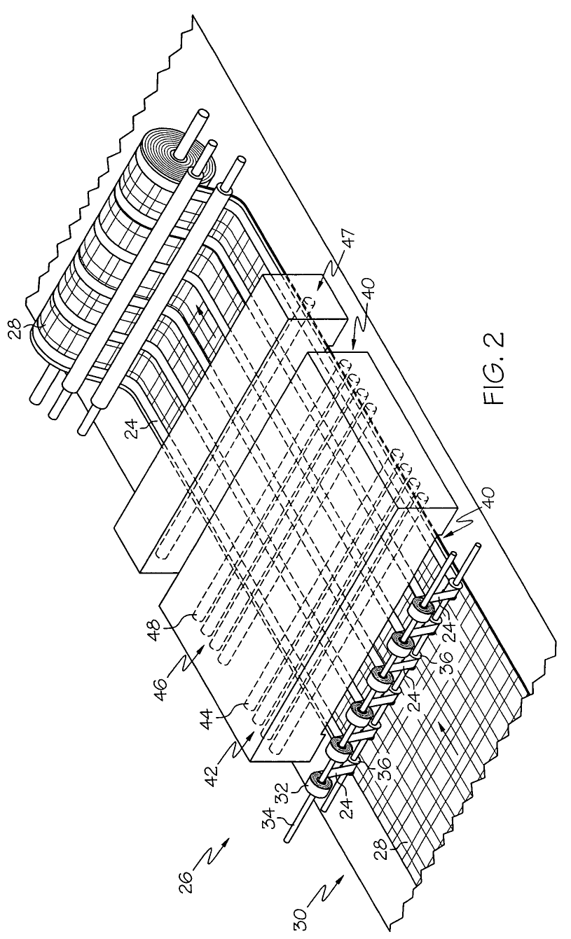

FIG. 2 illustrates an apparatus 26 for applying the adhesive in the form of a web 24 to a length of fabric 28. As shown, the apparatus is continuous and includes a conveyor 30 for supporting and feeding the length of fabric. The apparatus may also include an optical fabric edge tracker (not shown) which maintains a constant path as the fabric proceeds through the apparatus. The apparatus preferably further includes a brake unit (not shown) to control the fabric as it unwinds onto the conveyor. The apparatus may also include one or more measuring devices (not shown) on the conveyor.

The apparatus also includes a plurality of rotatable rolls 32 containing the adhesive web 24. The rolls 32 are supported above the fabric, preferably on a bar 34. As shown, the rolls are positioned at spaced intervals across the width of fabric. It should be appreciated that the spacing of the rolls may be adjusted so as to vary the application of adhesive as desired. The apparatus further includes a series of rotatable guide rolls 36 for applying the adhesive web 24 to the fabric. As shown, the guide rolls 36 are positioned in alignment with the rolls 32 and are preferably mounted on an aluminum shaft.

Downstream from the rolls is a tunnel 40 including a device for heating the adhesive web so that it adheres to the back face 14 of the fabric and a device for cooling the adhesive after it is applied to the fabric. The heating device 42 preferably comprises a series of heating bars 44 positioned across the top and bottom of the tunnel. The heating bars 44 heat the adhesive 24 as the fabric passes through the tunnel, causing the adhesive to melt and impregnate the nap of the fabric 28. After passing through the heating device 42, the fabric is passed through a cooling device 46 which comprises a plurality of cooling bars 48. The bars are cooled by water flowing through the bars.

After passing through the cooling device 46, the adhesive on the fabric is sufficiently cooled such that it is not tacky when it exits the tunnel 40. Optionally, the apparatus may include an ultraviolet light source 47 which enables visual inspection of the adhesive on the fabric to ensure sufficient coverage. The fabric is then preferably rolled up using conventional rewinding equipment so that the fabric may be stored or transported for further processing.

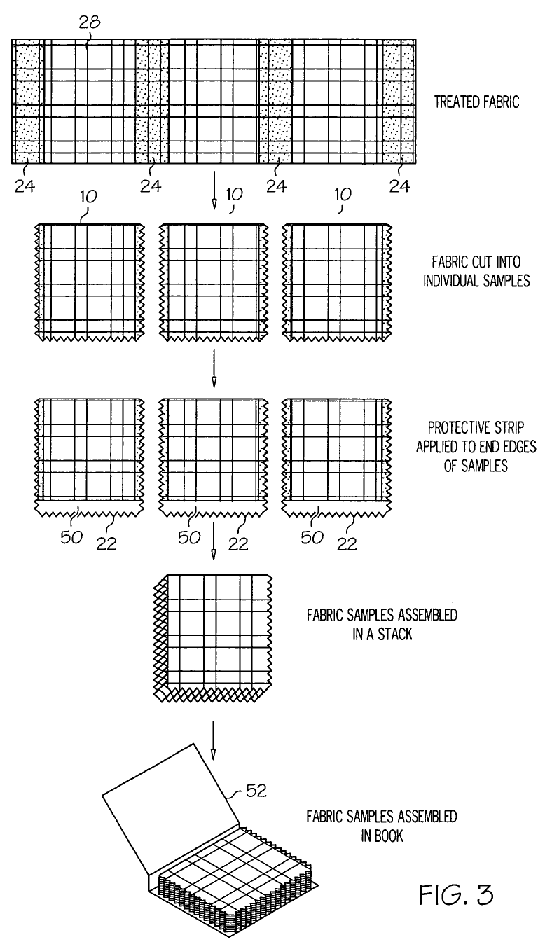

FIG. 3 is a flow diagram illustrating further processing of the treated fabric. As shown, the length of fabric 28 containing adhesive 24 at spaced intervals across the width of the fabric is cut into a series of individual fabric samples 10. The fabric may be cut using conventional cutting equipment used in the fabric industry. The individual fabric samples are preferably cut such that the edges are pinked, which also aids in preventing fraying of the fabric edges.

A protective strip 50 of paper or plastic material is then preferably adhered to at least one end edge 22 of the fabric samples. The strip may be adhered using a conventional adhesive as is known in the art.

The individual fabric samples are then assembled in a stack such that the front face 12 of each fabric sample faces upward and the back face 14 of the fabric sample containing the adhesive 24 and the protective strip 50 faces downward. The fabric samples may then be assembled in a book or binder 52 as is conventional in the art.

It will be apparent to those skilled in the art that various changes may be made without departing from the scope of the invention which is not considered limited to what is described in the specification.

1. A method of making fabric samples comprising:
providing a length of fabric;
applying an adhesive along the length of said fabric at predetermined intervals; and
cutting said fabric into a series of fabric samples having first and second side edges and first and second end edges such that said adhesive overlies said first and second side edges of each fabric sample and prevents fraying of said edges.

2. The method of claim 1 wherein said adhesive is in the form of a web.

3. The method of claim 1 including heating said adhesive after applying said adhesive to said fabric.

4. The method of claim 2 including cooling said adhesive after heating said adhesive.

5. The method of claim 1 wherein said fabric has a front face and a back face and said adhesive is applied to said back face.

6. The method of claim 1 including adhering a strip of paper or plastic to at least one end edge of each adhesive-treated fabric sample.

7. The method of claim 6 including assembling said series of fabric samples in the form of a stack.

8. The method of claim 7 including assembling said stacked fabric samples in a book or binder.

9. The method of claim 1 wherein said adhesive comprises a hot melt adhesive.

10. An apparatus for making fabric samples comprising:
a conveyor for supporting and feeding a length of fabric;
a plurality of rotatable rolls supported above said fabric and positioned at predetermined intervals across the width of said fabric, said rolls containing an adhesive for application to said fabric;
a plurality of rotatable guide rolls positioned in alignment with said plurality of adhesive-containing rolls for applying said adhesive along the length of said fabric at said predetermined intervals; and
a device for heating and adhering said adhesive to said fabric.

11. The apparatus of claim 10 wherein said heating device comprises a plurality of heated bars.

12. The apparatus of claim 10 further including a mechanism for cooling said adhesive after it is adhered to said fabric.

13. The apparatus of claim 12 wherein said cooling mechanism comprises a plurality of cooling bars.

14. The apparatus of claim 10 wherein said adhesive is in the form of a web.

15. A sample book containing a series of fabric samples prepared by the method of claim 1.

16. A sample book containing a series of fabric samples having first and second side edges, wherein each of said fabric samples includes an adhesive along said first and second side edges for preventing fraying of said edges.

17. A fabric sample formed by the method of claim 1.

18. A fabric sample having first and second side edges and first and second end edges, said first and second side edges including an adhesive thereon for preventing fraying of said edges, said fabric sample further including a strip of paper or plastic on at least one of said first and second end edges.
